(19) United States
(12) Patent Application Publication
(10) Pub. No.: US 2008/0041184 A1
(43) Pub. Date: Feb. 21, 2008

(54) Method For Fixing A Flexible Drive Shaft In A Thrust Reverser And A Thrust Reverser Of This Type

(75) Inventors: Gautier Chapuis, Saint Lambert des Bois (FR); Joachim Mirabaud, Alfortville (FR)

Correspondence Address: OLIFF & BERRIDGE, PLC, P.O. BOX 320850, ALEXANDRIA, VA, 22320-4850, US

(73) Assignee: AIRCELLE, Gonfreville L'Orcher (FR)

(21) Appl. No.: 11/791,039

(22) PCT Filed: Dec. 15, 2005
(86) PCT No.: PCT/FR05/03136

§ 371 Date: May 18, 2007

(30) Foreign Application Priority Data
Jan. 21, 2005 (FR) 0500623

(51) Int. Cl. F16C 1/10

(52) U.S. Cl. 74/502.4; 244/110 B; 403/345

(57) ABSTRACT

The embodiments relate to a method for fixing a flexible drive shaft in a front frame of a thrust reverser, this front frame being realized with the aid of two partially open semicircular elements. The method includes a step during which a first end of this shaft is linked to a drive system fixed in an element of the front frame, wherein it includes the steps serving to: position at least one fixing sleeve around the shaft; joining at least on fixing support to the thrust reverser; connecting the second end of the shaft to a drive system fixed in the other element of the front frame; force-inserting each fixing sleeve into a seat provided by the associated fixing support in order to hold the shaft in a predetermined position. The embodiments also relate to a thrust reverser used in aeronautics having a fixing sleeve placed around the drive shaft.

The present invention relates, on the one hand, to a method for fixing a flexible drive shaft in a front frame of a thrust reverser, said front frame being produced with the aid of two partially open semicircular elements, and, on the other hand, to a thrust reverser comprising at least one drive shaft fixed according to this method.

The role of a thrust reverser is to improve the braking capacity of an aircraft by redirecting forward at least a portion of the thrust generated by the turbojet. In this phase, the reverser obstructs the gas exhaust nozzle and directs the exhaust stream from the engine toward the front of the nacelle, thereby generating a counter-thrust that supplements the braking of the aircraft wheels.

The means used to produce this reorientation of the stream vary depending on the type of reverser. However, in all cases, the structure of a reverser comprises movable covers that can be moved between, on the one hand, a deployed position in which they open in the nacelle a passageway intended for the diverted stream, and, on the other hand, a retracted position in which they close this passageway. These movable covers may also fulfill a function of diversion or simply of activation of other means of diversion.

In general, these movable covers are actuated by cylinders controlled by drive systems fixed into the front frame of the thrust reverser. In a conventional manner, the front frame consists of two semicircular elements in which the various drive systems are fixed. The connection between two drive systems placed respectively in one and in the other of the two semicircular elements is provided with the aid of a flexible drive shaft. To do this, the latter has, on the one hand, a first end attached to the drive system situated on one of the two elements, and, on the other hand, a second end attached to the other element.

Clearly, such a drive shaft must be held in a well determined position at the front frame. For this, clamping rings provided with attachment lugs intended to be screwed into support plates fixedly attached to the reverser are placed evenly along the whole length of the drive shaft. However, it is very awkward for an operator to fix each clamping ring in an associated support plate. This is particularly so when the two semicircular elements of the front frame are partially open in the top portion of the thrust reverser and the operator wants to fix the drive shaft in this region. Specifically, since the mobility of the operator is restricted, the main disadvantage lies in the fact that the latter has great difficulty properly carrying out the delicate operation of screwing the clamping ring into the associated support plate. Consequently, the execution of this phase is usually extremely costly in time and the risks of people falling should not be excluded.

The object of the present invention is to remedy the aforementioned disadvantages, and for this reason consists in a method for fixing a flexible drive shaft in a front frame of a thrust reverser, said front frame being produced with the aid of two partially open semicircular elements, this method comprising a step during which a first end of said drive shaft is attached to a drive system fixed in an element of the front frame, characterized in that it comprises the steps intended to:
position at least one fixing sleeve around the drive shaft,
fixedly attach at least one fixing support to the thrust reverser,
connect the second end of the drive shaft to a drive system fixed in the other element of the front frame,
force-fit each fixing sleeve into a housing presented by the associated fixing support in order to hold the drive shaft in a predetermined position.

Thus, in the fixing method according to the invention, instead of the step of screwing a clamping ring into a support plate for which precision tools have to be manipulated, there is a step during which a fixing sleeve is quite simply force-fitted into the housing of the associated fixing support, which finally makes it possible to hold the drive shaft in a predetermined position. Clearly, this fixing sleeve may be made in a single piece or may be made with the aid of several adapted parts.

Advantageously, a fixing support is positioned between the two partially open elements constituting the front frame. In addition, these two elements are usually partially open in the top portion of the thrust reverser.

Preferably, provision is made to arrange at least one positioning means in each fixing sleeve capable of interacting with a matching positioning means made in the associated fixing support. For example, each fixing sleeve may comprise at least one groove in which a protrusion presented by the associated fixing support can be engaged.

The present invention also relates to a thrust reverser used in aviation having a front frame comprising two semicircular elements fitted with at least one flexible drive shaft having, on the one hand, a first end attached to a drive system fixed in one element constituting the front frame, and, on the other hand, a second end attached to a drive system fixed in the other element, characterized in that at least one fixing sleeve is positioned around the drive shaft, and in that each fixing sleeve is force-fitted into a housing presented by an associated fixing support fixedly attached to said thrust reverser, in order to hold the drive shaft in a predetermined position.

Advantageously, each fixing support comprises a sheath defining a housing of substantially circular section. In addition, this sheath preferably has a longitudinal opening whose passageway section is slightly greater than the diameter of the drive shaft.

Preferably, each fixing sleeve is of circular section and has a diameter that is slightly greater than that of the sheath of the associated fixing support.

Again advantageously, each fixing sleeve is provided with at least one positioning means capable of interacting with a matching positioning means presented by the associated fixing support. For example, each fixing sleeve may comprise at least one groove in which a protrusion presented by the associated fixing support is engaged.

In addition, each fixing sleeve may comprise a first and a second beveled end.

The invention will be better understood with the aid of the detailed description that is given below with respect to the appended drawing, in which:

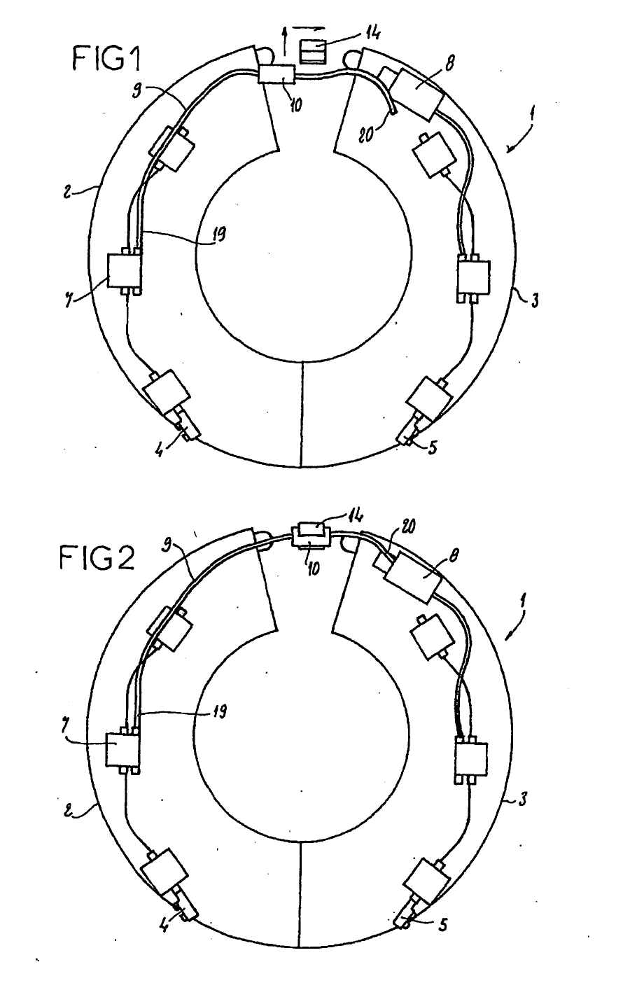

FIG. 1 is a schematic front view of the front frame of a thrust reverser according to the invention, during the step of fixing the flexible drive shaft;

FIG. 2 is a view similar to that represented in FIG. 1, once the drive shaft is properly fixed;

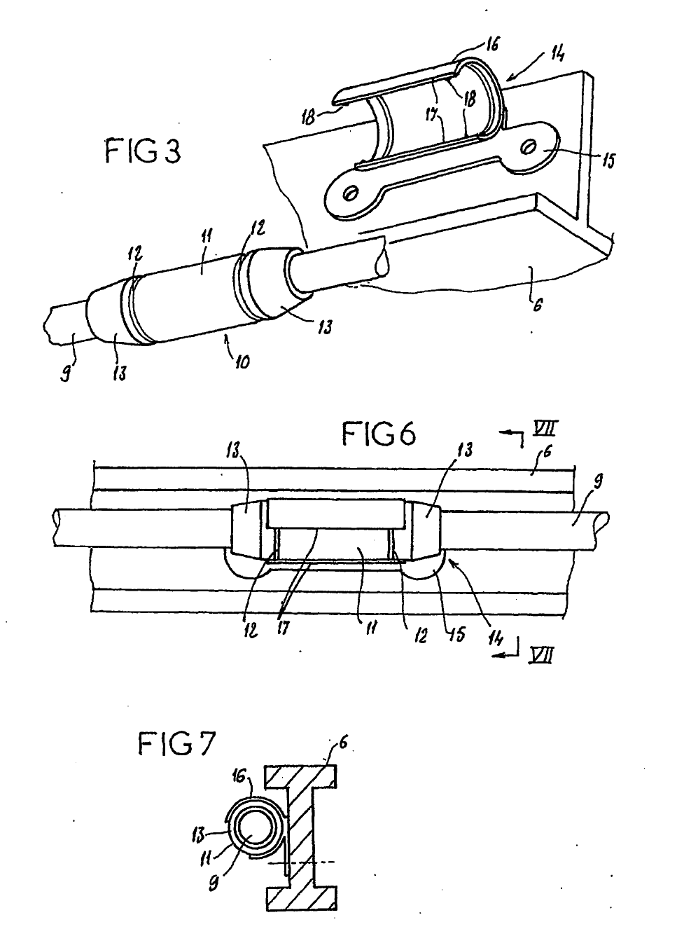

FIG. 3 is a partial view in perspective of a drive shaft furnished with a fixing sleeve and an associated fixing support;

FIG. 4 is a partial front view of the drive shaft and of the fixing support represented in FIG. 3;

FIG. 5 is a view similar to FIG. 4, once the drive shaft is engaged in the fixing support;

FIG. 6 is a view similar to FIG. 4, once the fixing sleeve is engaged in the fixing support;

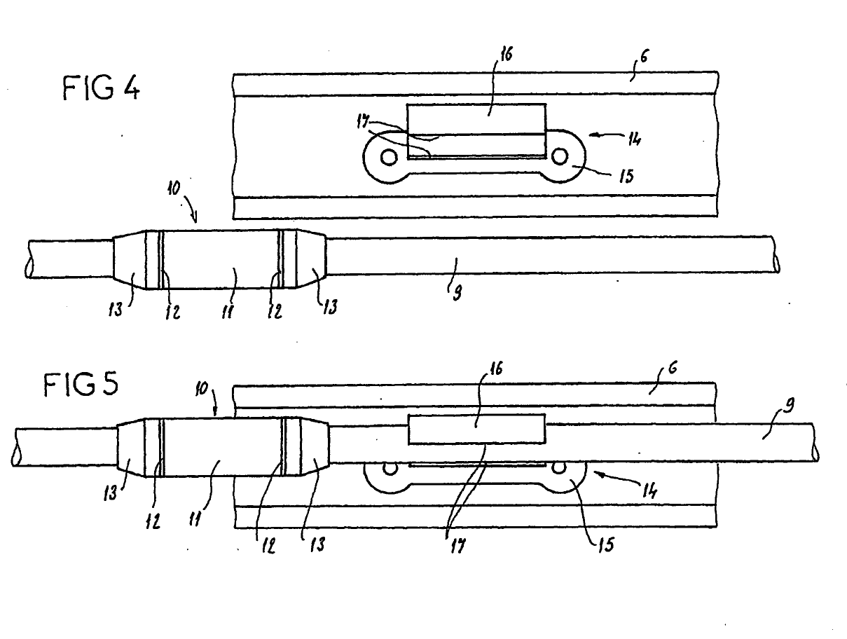

FIG. 7 is a view in section along the line VII-VII of FIG. 6.

A front frame 1 of a thrust reverser as shown in FIGS. 1 and 2 is produced with the aid of two semicircular elements 2, 3 to which longitudinal panels (not shown) are attached. Depending on whether the thrust reverser has doors or grilles, these panels are then respectively fixed or movable in translation. Irrespective of the configuration, the front frame 1 is fitted with cylinders 4, 5 that have the function, depending on the case, either of deploying the diverting doors, or moving the movable panels in translation to which the diverting grilles are connected.

These elements 2, 3 are articulated relative to one another by means of at least one connecting rod 6 which extends between them, in the top portion of the thrust reverser. As shown in FIGS. 1 and 2, these elements 2, 3 may then be partially open in the top portion to allow maintenance personnel to access the inside of the thrust reverser.

Furthermore, the cylinders 4, 5 are controlled by drive systems 7, 8 fixed respectively in the elements 2, 3 of the front frame 1. In a conventional manner, these drive means 7, 8 are intended to be connected to one another by means of a flexible drive shaft 9 also called a “flexshaft”.

A fixing sleeve 10, defining a channel whose internal diameter is very slightly greater than that of the drive shaft 9, is slid along the latter. This fixing sleeve 10, as shown in FIGS. 3 to 7, is made of rubber and comprises, on the one hand, a central zone 11 surrounded by two grooves 12, and, on the other hand, two beveled ends 13.

A metal fixing support 14 is also fixedly attached to the connecting rod 6 providing the connection between the two elements 2, 3. When the latter are partially open, the fixing support 14 is therefore positioned between the two elements 2, 3 and thus remains in the field of vision of the personnel.

More precisely, this fixing support 14 is divided, on the one hand, into a base 15 screwed into the connecting rod 6, and, on the other hand, a sheath 16 of circular section having two longitudinal edges 17 defining a longitudinal opening. The sheath 16 is fixedly attached to the base 15 and is designed so as to have a certain radial elasticity. In addition, this sheath 16 is fitted with protrusions 18 designed to interact with the grooves 12 of the sleeve 10. The two edges 17 are spaced from one another at a distance that is greater than the diameter of the drive shaft 9, but less than the largest diameter of the fixing sleeve 10. Similarly, the diameter of the sheath 16 is less than the largest diameter of the fixing sleeve 10.

As shown more specially in FIG. 1, when a qualified operator wishes to connect the two drive systems 7, 8 to one another with the aid of the drive shaft 9, this operator begins by connecting a first end 19 of the drive shaft 9 to the drive system 7 housed in the element 2.

Then, with reference to FIG. 2, he moves to the side of the element 3 and connects the second end 20 of the drive shaft 9 to the drive system 8 housed in the element 3.

This operator then only has to insert the fixing sleeve 10 into the sheath 16 of the fixing support 14 for the drive shaft 9 to be perfectly held in position. To do this, as shown more precisely in FIG. 5, he first of all inserts a portion of the drive shaft 9 situated downstream of the fixing sleeve 10 into the sheath 16. Then, he pulls on the drive shaft 9 until the beveled end 13 downstream of the fixing sleeve 10 enters the sheath 16. Once that is done, and as shown in FIG. 6, the operator can exert a greater pull to force the fixing sleeve 10 to slide into the sheath 16. The latter then deforms radially and its protrusions 18 are each finally made to penetrate one of the two grooves 12 of the fixing sleeve 10. The latter and the drive shaft 9 are then perfectly held in position in the front frame 1.

It must be understood that an evident variant embodiment of the invention may consist in the fact that the operator inserts the fixing sleeve 10 into the associated fixing support 14 before connecting the second end 20 of the drive shaft 9 to the drive system 8.

Although the invention has been described in connection with particular exemplary embodiments, it is evident that it is in no way limited thereto and that it includes all the technical equivalents of the means described and their combinations if the latter enter into the context of the invention.

1. A method for fixing a flexible drive shaft in a front frame of a thrust reverser, said front frame being produced with the aid of two partially open semicircular elements, this method comprising a step during which a first end of said drive shaft is attached to a drive system fixed in an element of the front frame, wherein it comprises the steps intended to:
position at least one fixing sleeve around the drive shaft,
fixedly attach at least one fixing support to the thrust reverser,
connect the second end of the drive shaft to a drive system fixed in the other element of the front frame,
force-fit each fixing sleeve into a housing presented by the associated fixing support in order to hold the drive shaft in a predetermined position.

2. The fixing method as claimed in claim 1, wherein a fixing support is positioned between the two partially open elements constituting the front frame.

3. The fixing method as claimed in claim 1, wherein the two elements constituting the front frame are partially open in the top portion of the thrust reverser.

4. The fixing method as claimed in claim 1, wherein at least one positioning means is arranged in each fixing sleeve capable of interacting with a matching positioning means made in the associated fixing support.

5. The fixing method as claimed in claim 4, wherein each fixing sleeve comprises at least one groove in which a protrusion presented by the associated fixing support can be engaged.

6. A thrust reverser used in aviation having a front frame comprising two semicircular elements fitted with at least one flexible drive shaft having, on the one hand, a first end attached to a drive system fixed in one element constituting the front frame, and, on the other hand, a second end attached to a drive system fixed in the other element, wherein at least one fixing sleeve is positioned around the drive shaft, and in that each fixing sleeve is force-fitted into a housing presented by an associated fixing support fixedly attached to said thrust reverser, in order to hold the drive shaft in a predetermined position.

7. The thrust reverser as claimed in claim 6, wherein each fixing support comprises a sheath defining a housing of substantially circular section.

8. The thrust reverser as claimed in claim 7, wherein the sheath has a longitudinal opening whose passageway section is slightly greater than the diameter of the drive shaft.

9. The thrust reverser as claimed in claim 7, wherein each fixing sleeve is of circular section and has a diameter that is slightly greater than that of the sheath of the associated fixing support.

10. The thrust reverser as claimed in claim 6, wherein each fixing sleeve is provided with at least one positioning means capable of interacting with a matching positioning means presented by the associated fixing support.

11. The thrust reverser as claimed in claim 10, wherein each fixing sleeve comprises at least one groove in which a protrusion presented by the associated fixing support is engaged.

12. The thrust reverser as claimed in claim 6, wherein each fixing sleeve comprises a first and a second beveled end.
